(19) United States
(12) Patent Application Publication
(10) Pub. No.: US 2004/0193634 A1
(43) Pub. Date: Sep. 30, 2004

(54) Managing regulatory information

(76) Inventors: Guy Goodlett, Boise, ID (US); John Monroe, Palo Alto, CA (US); Kathleen S. Pickett, Brush Prairie, WA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/395,980

(22) Filed: Mar. 25, 2003

(51) Int. Cl. G06F 17/00

(52) U.S. Cl. 707/102

(57) ABSTRACT

Systems and methods of managing regulatory information are described. In one aspect, a library of submittal components is accessed. Each submittal component specifies respective submittal content. The submittal component library is queried based at least in part on information relating to a regulated product and at least one regulatory approval objective, wherein each approval objective specifies a compliance approval type and a target market in which the product is regulated. Based on the submittal component library query, a universal submittal package is generated. The universal submittal package comprises a set of submittal components for generating at least one submittal package. In another aspect, regulatory rules are accessed. The regulatory rules specify content required to satisfy at least one regulatory approval objective for at least one regulatory agency in a respective target market in which a product is regulated. A library of submittal components is built. Each submittal component specifies respective submittal content and each is linked to at least one approval objective.

### CROSS-REFERENCE TO RELATED APPLICATIONS

1. Technical Field

This invention relates to systems and methods of managing regulatory information.

2. Background

Many markets (e.g., countries, regions, or other geographic locations) require evidence that a product complies with one or more regulatory standards (e.g., electromagnetic compliance standards, safety compliance standards, and telecommunications compliance standards) before the product may be sold legally into these markets. Evidence of a product's compliance with such standards typically is submitted to a regulatory agency in a “submittal package.” In general, each geographic location promulgates its own set of product compliance standards and, oftentimes, there is little similarity across countries/regions as to what evidentiary items (e.g., documents, product samples, photographs, and test reports) are required to prove compliance with respect to the same approval objectives (e.g., evidence of compliance with safety standards).

A company wishing to sell a product into a target region or country typically employs a Technical Regulations and Standards Engineer (TRSE) who represents the company to regulatory agencies in that region or country. Each TRSE identifies all evidentiary items that must be submitted to the regulatory agencies in his or her assigned country in order to prove compliance for each approval type. Regulations in each target region or country often are changed frequently. As a result, each TRSE continually must update the list of requirements for each compliance approval type.

Each TRSE typically works with a Regulatory Engineer (Regs Engineer) who works in a product generation organization (PGO) of the company and is responsible for ensuring that a particular set of products complies with regulatory standards that are promulgated by the target region or country. When a new product introduction is planned, the Regs Engineer that is assigned to the new product contacts the TRSE for each and every country into which the product will be sold. In response, each TRSE creates a respective checklist of items required to prove compliance in his or her country or region. The Regs Engineer receives all of the checklists from the TRSEs. In the various checklists that are received from the TRSEs for a product, similar items (e.g., a front-view photograph of the product) typically are specified differently. Consequently, there are few opportunities for a Regs Engineer to re-use similar items in different submittal packages and, therefore, few opportunities to reduce duplication of effort.

### SUMMARY

The invention features systems and methods of managing regulatory information.

In one aspect of the invention, a library of submittal components is accessed. Each submittal component specifies respective submittal content. The submittal component library is queried based at least in part on information relating to a regulated product and at least one regulatory approval objective, wherein each approval objective specifies a compliance approval type and a target market in which the product is regulated. Based on the submittal component library query, a universal submittal package is generated. The universal submittal package comprises a set of submittal components for generating at least one submittal package.

In another aspect of the invention, regulatory rules are accessed. The regulatory rules specify content required to satisfy at least one regulatory approval objective for at least one regulatory agency in a respective target market in which a product is regulated. A library of submittal components is built. Each submittal component specifies respective submittal content and each is linked to at least one approval objective.

Other features and advantages of the invention will become apparent from the following description, including the drawings and the claims.

### DESCRIPTION OF DRAWINGS

FIG. 1 is a diagrammatic view of a regulatory information management system and various entities that interact with the regulatory information management system to build a library of submittal components and to generate submittal packages based on the submittal component library.

FIG. 2A is a flow diagram of a method of building a library of submittal components.

FIG. 2B is a graphical user interface displaying submittal components of a universal submittal component library organized into a hierarchical tree structure.

FIG. 3 is a block diagram of a system for managing regulatory information.

FIG. 4 is a flow diagram of a method of managing regulatory information.

FIG. 5 is a workflow diagram of a method of managing regulatory information.

FIG. 6 is a flow diagram of a method of creating a universal submittal package.

FIG. 7 is a graphical user interface for initiating a submittal project for a product.

FIG. 8 is a graphical user interface for collecting general information for a submittal project.

FIG. 9 is a graphical user interface for specifying a pre-existing submittal project from which to leverage information.

FIG. 10 is a graphical user interface for specifying at least one geographic location into which a product will be sold.

FIG. 11 is a graphical user interface for specifying information relating to at least one campus that will build at least one regulated item that will be incorporated in a product.

FIG. 12 is a graphical user interface for associating approval types with respective geographic locations to define respective approval objectives.

FIG. 13 is a graphical user interface for specifying expected approval dates for at least one geographic location.

FIG. 14 is a graphical user interface for specifying business entities that will obtain certification for at least one approval objective.

FIG. 15 is a graphical user interface for presenting a user with a set of one or more questions generated by predefined business rules.

FIG. 16A is a graphical user interface for identifying components selected by predefined business rules for a new, non-leveraged submittal package.

FIG. 16B is a graphical user interface for identifying components selected by predefined business rules for a reconfigured, pre-existing submittal package.

FIG. 16C is a graphical user interface for identifying components selected by predefined business rules for a leveraged pre-existing submittal package.

FIG. 17 is a graphical user interface for summarizing the configuration of a submittal package.

FIG. 18 is a block diagram of an object model for a submittal project.

FIG. 19 is a graphical user interface for adding a submittal component to an automatically generated universal submittal package.

FIG. 20 is a flow diagram of a method of managing regulatory information.

FIG. 21 is a graphical user interface for assigning submittal content creation tasks to one or more content creators.

FIG. 22 is a graphical user interface for notifying a user that a submittal project phase is ready for release and for enabling the user to release that phase of the submittal project.

FIG. 23 is a flow diagram of a method of completing an agency-specific work package.

FIG. 24 is a graphical user interface for assigning submittal components of an agency-specific work package to one or more reviewers.

FIG. 25 is a graphical user interface for publishing a final version of an agency-specific submittal package.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

I. Introduction

As used herein, a Technical Regulations and Standards Engineer (hereinafter “TRSE”) is a person who represents a company, an enterprise or other organization to at least one regulatory agency in a particular geographic area (e.g., a country or region). A Regulatory Engineer (hereinafter “Regs Engineer”) is a person who works at a Product Generation Organization (hereinafter “PGO”) and is responsible for ensuring that a particular set of products complies with regulatory standards promulgated by regulatory agencies of the countries or regions into which the particular set of products are intended to be sold.

The embodiments that are described in detail below facilitate the management of regulatory information transferred between a TSRE and a Regs Engineer. For example, these embodiments facilitate the assignment of responsibilities to TSREs and Regs Engineers across business divisions, and support these assignments with common processes and databases. Some embodiments enable a uniform library of submittal components (e.g., templates for forms, test reports, photographs, and physical item shipment records, corresponding to content required to prove compliance with one or more aspects of a regulatory approval regulation) to be built based on regulatory information obtained by TRSEs for different markets (e.g., countries, regions, or other geographic locations). In some embodiments, a universal submittal package (or USP), which is populated with components from the submittal components library, is created automatically based on information received from a Regs Engineer about a product for which regulatory compliance approval is being sought. In some embodiments, a universal submittal package includes the smallest set of submittal components needed to satisfy all approval types for all markets into which a particular product is intended to be sold. Various agency-specific submittal packages, which correspond to pre-defined subsets of a universal submittal package, may be generated automatically and transmitted to respective TRSEs for review and submission to the appropriate regulatory agencies in the designated target markets.

From a universal submittal package that is generated for a particular product, a Regs Engineer is able to see all of the submittal content that is required to obtain all of the specified regulatory approvals across all target regions/countries. The productivity of a Regs Engineer may be improved by reducing duplication of effort and by facilitating re-use of similar submittal contents for different submittal packages. In addition, the productivity of a TRSE may be improved by reducing errors and omissions in submittal packages that are received from Regs Engineers. The results of the submittal packaging process are also improved by presenting regulatory agencies with submittal packages having a uniform format, making it easier for agency officials to review and approve submissions.

The following disclosure is divided into two sections. Section II describes embodiments of a regulatory information management process for building a submittal components library. Section III describes embodiments of a regulatory information management system and methods of generating submittal packages based at least in part on the submittal components library.

II. Building a Submittal Components Library

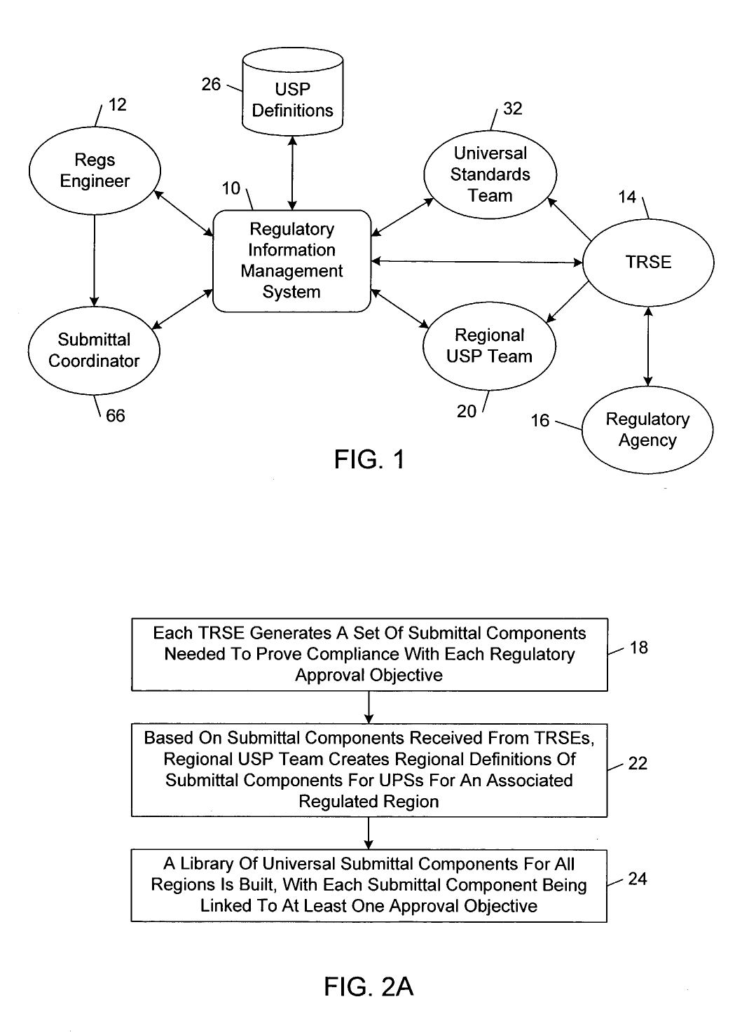

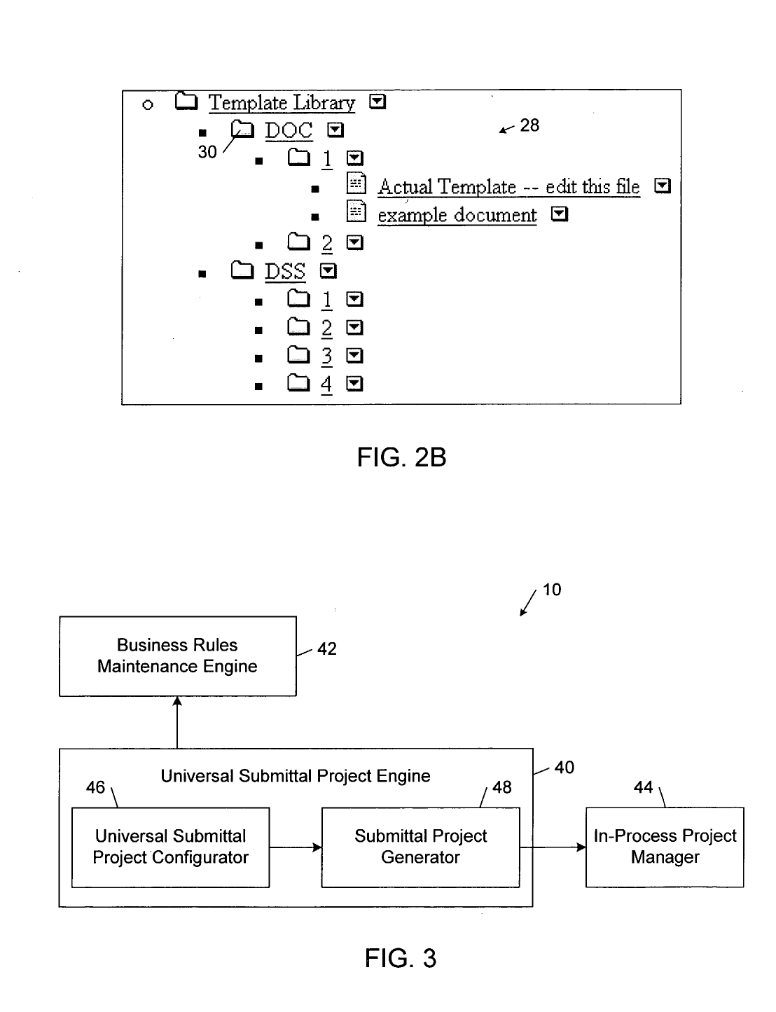

Referring to FIGS. 1, 2A, and 2B, in some embodiments, a submittal components library may be built as follows.

Initially, each TRSE 14 interprets regulatory rules that are promulgated by regulatory agencies 16 in the markets (as used hereinafter, the terms “market” and “region” and “country” will be used interchangeably) for which each TRSE is responsible. Based on these rules, each TRSE generates a set of submittal components that are needed to prove compliance with respect to each regulatory approval objective (step 18). As used herein, the term “regulatory approval objective” corresponds to a specific compliance approval type being sought for a specific target region. A compliance approval type corresponds to a category into which a specific approval request may be classified. Among the common compliance approval types are electromagnetic compliance approvals (EMCs), safety compliance approvals, and telecommunication compliance approvals.

Submittal components specify specific submittal content that is considered to be sufficient evidence of proof of compliance with a respective aspect of a regulatory approval standard promulgated by a regulatory agency. Submittal content may include content of the following types: documents, forms, test reports, photographs, and physical item shipment records. Exemplary submittal contents include:

CB Report & Certificate, including Schematics

EMC Report

Summary EMC Report

Declaration of Conformity

Declaration of Similarity

Product Photographs

Parts List

User's Manual

Product Data Sheet

Product Labels

Various Application Letters

Based on the submittal components that are received from the TRSEs, Regional USP Teams 20 create regional definitions of submittal components for universal submittal packages (USPs) for associated regions (step 22). In general, a regional USP team attempts to distill the various definitions or descriptions of the required submittal contents into a uniform set of submittal component definitions (e.g., in the form of templates) for a respective region and, thereby, facilitate the re-use of submittal contents once they have been generated. A library of universal submittal components for all regions is built based on the submittal component definitions created by the regional USP teams (step 24). Each submittal component is linked to a respective approval objective, which represents a specific region and approval type (e.g., Mexico-safety). The library of submittal components may be stored in a database 26 that may be accessed by a regulatory information management system, 10.

Referring to FIG. 2B, in some embodiments, the submittal component library (or template library) may be organized in a two-tier folder structure 28. An item that appears in the first level of this folder structure represents a container for all of the data associated with a submittal component. For example, in the illustrated embodiment, the DOC folder 30 contains all of the information associated with the Declaration of Conformity submittal component. The second level of folder structure 28 is used to manage different versions of each submittal component. For example, in the illustrated embodiment, the DOC submittal component has two different versions (1 and 2), and the DSS submittal component has four different versions (1, 2, 3, and 4). The version folders of a submittal component may contain two types of documents. The first document type is referred to as “submittal component content” and represents files that will be edited by Regs Engineers 12 during the In-Process phase of a submittal project (described below). In the illustrated embodiment, the document entitled “Actual Template—edit this file” represents an instance of submittal component content. The second document type is referred to as “submittal component collateral” and represents supporting information about the associated submittal component. In the illustrated embodiment, the document entitled “example document” represents an instance of submittal component collateral.

III. Generating Regulatory Submittal Packages

A. System Overview

Referring to FIG. 3, in some embodiments, a regulatory information management system 10 includes a universal submittal package engine 40, a business rules maintenance engine 42, and an in-process project manager 44. Universal submittal package engine 40 includes a universal submittal project configurator 46 and a submittal project generator 48. Universal submittal package configurator 46 presents a project initiator (e.g., a Regs Engineer) with a series of questions to determine what product, country, approval type, etc. is required for a submittal project. The universal submittal project configurator 46 guides the user through the series of questions. In some embodiments, new questions are presented based on the answers to prior questions. The business rules maintenance engine 42 is the application in which the Regional USP Team creates, modify, and delete the questions and answers and business rules that the universal submittal project configurator 46 presents. The universal submittal project configurator 46 creates a USP Project Configuration object containing responses to the questions. Submittal project generator 48 interprets the answers in the USP Project Configuration object and based on the rule system for these answers creates a submittal project using the appropriate templates, tasks, and documents required for the specific type of product, country, and approval type. The in-process project manager 44 allows the initiator of a submittal project (e.g., a Regs Engineer or other PGO initiator) and TRSE to work on the tasks, templates and documents that are to be assembled during the submittal package generation process.

B. Process Overview

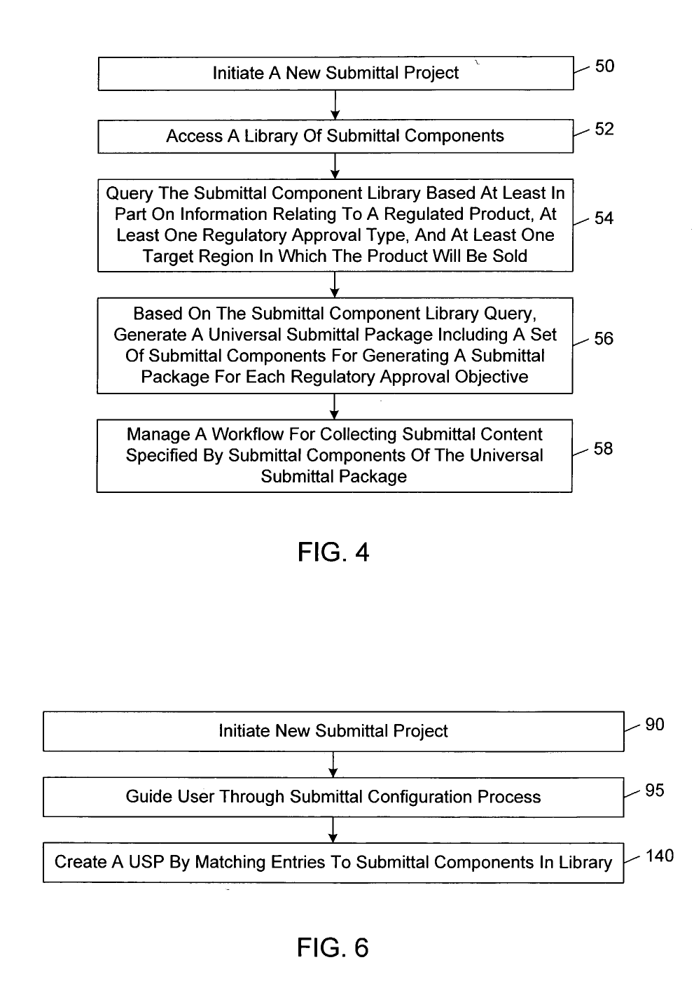

Referring to FIG. 4, in some embodiments, regulatory information management system 10 facilitates the management and transfer of regulatory information between a submittal project initiator (e.g., Regs Engineer) and a TRSE as follows. The submittal project configuration process begins when a submittal project initiator in a particular division initiates a new submittal project with the regulatory information management system 10 (step 50). In the following description, the project initiator will be assumed to be a Regs Engineer. Regulatory information management system 10 accesses a library of submittal components (step 52) and queries the submittal component library based at least in part on information received from the Regs Engineer, including product information, at least one regulatory approval type, and at least one target region into which the product will be sold (step 54). Based on the submittal component library query (step 54), the regulatory information management system 10 generates a universal submittal package, which includes a set of submittal components for generating one or more submittal packages that collectively address all of the user-specified regulatory approval objectives (step 56). Regulatory information management system 10 then manages a workflow for collecting submittal content specified by submittal components of the universal submittal package that was generated for the submittal project (step 58).

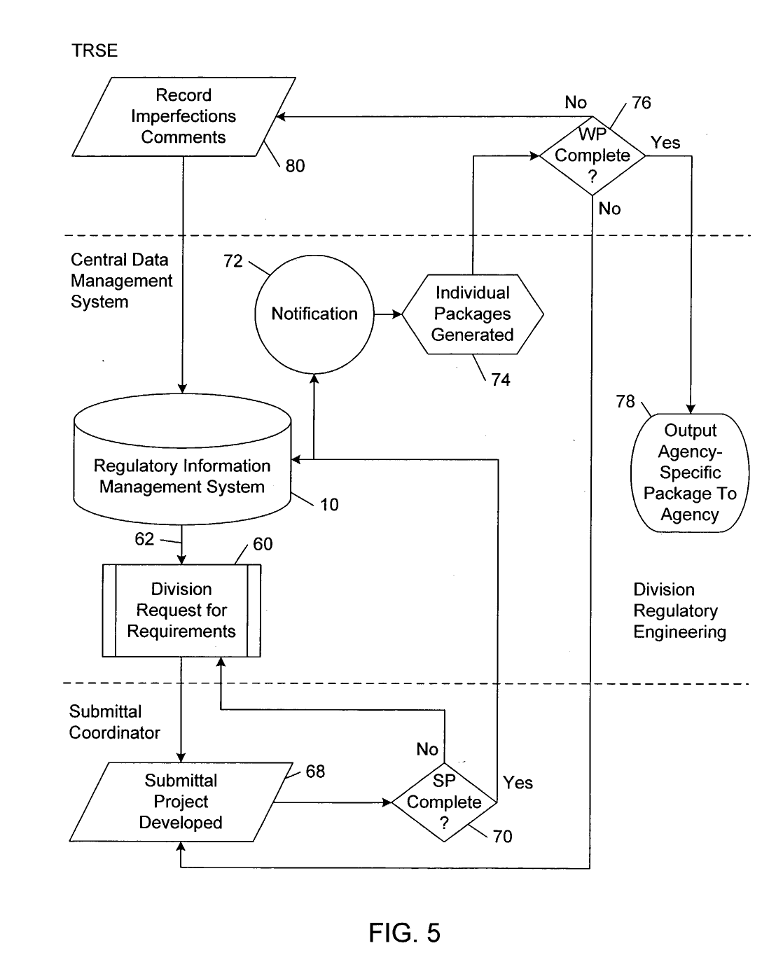

As shown in FIG. 5, in response to a request for submittal requirements for a particular submittal project (step 60), regulatory information management system 10 transmits a universal submittal package 62 to the lead Regs Engineer. The lead Regs Engineer, with the optional assistance of a submittal coordinator 66 (FIG. 1), completes a submittal project by collecting submittal content specified by the submittal components of the universal submittal package 62 (step 68). After the universal submittal project has been completed (step 70), regulatory information management system 10 notifies the TRSEs that are responsible for the regions into which the product is intended to be sold (step 72) and generates individual, agency-specific work packages (WPs) for each region (step 74). If the TSREs determine that the work packages are complete (step 76), regulatory information management system 10 outputs properly formatted agency-specific submittal packages, which may be submitted to the corresponding regulatory agencies (step 78). If a TSRE determines that a particular work package is incomplete or contains errors, the TSRE enters specific comments into regulatory information management system 10 (step 80). Regulatory information management system 10 forwards these comments to the person or persons in the appropriate division who generated the submittal package content relating to the TSRE's comments.

C. Detailed Implementation

The implementation of regulatory information management system 10 is not limited to any particular hardware or software configuration. Indeed, regulatory information management system 10 may be implemented in any computing or processing environment, including in digital electronic circuitry or in computer hardware, firmware, or software. In the embodiments described below, regulatory information management system 10 is implemented as multiple software modules operating in the Livelink® collaboration and knowledge management software application environment (available from Open Text Corporation of Waterloo, Ontario, Canada).

1. Configuring A Universal Submittal Package

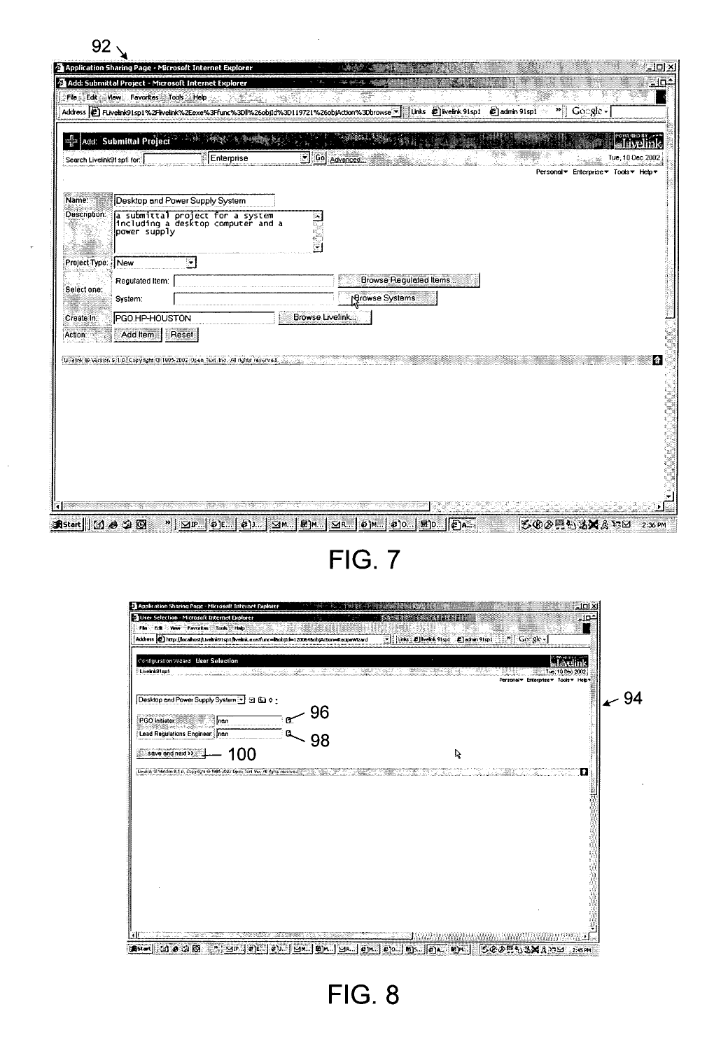

Referring to FIGS. 6 and 7, regulatory information management system 10 may be used to generate a submittal package for a product as follows. After a user (e.g., a Regs Engineer or other PGO initiator) logs into the system, the first step is to create a new submittal project (step 90). Regulatory information management system 10 opens an Add Submittal Project 92 page, which includes the following fields for configuring the new submittal project:

Name and Description: these are attributes that are applied to every object type. These attributes may be edited at any time.

Project Type: the user may select one of the following submittal project (SP) types: new, renewal, recertification, or update approval. Individual approval objectives also may reference these types.

Regulated Item: in this field, the user selects the regulated item (RI) for the submittal project. The Regs Engineer may select either a single RI or a system composed of several RIs.

The rules that govern which RI or system a PGO initiator may select are:

if the project type is “new”, then the user may select from any RI or system that is

associated with his or her PGO, AND

was not used in a previous submittal project

if the project type is “renewal”, then the user may select from any RI or system:

that is associated with his or her PGO, OR

for which his or her PGO is an Acknowledged Partner Division, OR

was used in a previous submittal project

if the project type is “recertification” or “update approval”, then the user may select from any RI or system:

that is associated with his or her PGO, AND

was used in a previous submittal project

In some embodiments, a configurator wizard guides the user through the configuration of the submittal project (step 95). For example, in some implementations, after entering submittal project-level information, the user chooses the RI he or she wants to configure from a list of RIs. In some embodiments, the configurator wizard guides the user through the configuration of that RI, and then returns to the list of RIs, where the user may choose another RI to configure. When all the desired RIs are configured, the user may proceed to a Summary page. From any configurator wizard page, the user may navigate backwards and forwards (as appropriate) by clicking back or save and next respectively. If the user chooses back, he or she is presented with the previous screen, containing the configuration information he or she selected on that screen. Selecting save and next inputs the page information and moves to the next page in the wizard.

In the illustrated embodiment, the configurator wizard pages occur in the following order:

User Selection

Submittal Project Leveraging

Geography Selection

Factory-Campus Information Confirmation

Approval Objective Selection

Expected Approval Date Selection

Certification Applicant Selection

Business Rule Questions

Selected Components

Summary Page

Wizard pages are not displayed if they are not applicable in a current configuration context. For instance, if there are no countries selected for approval that require campus certification, then the configurator 46 (FIG. 3) will not display the Campus Information Confirmation page to the user, and will go straight to the subsequent page. When all the desired RIs are configured, the user may proceed to the Summary page.

Referring to FIG. 8, a User Selection page 94 is used to collect general information about the submittal project, the name 96 of the PGO initiator of the submittal project, and the name 98 of the lead Regs Engineer for the submittal project, which may be the same as the name of the PGO initiator. The collection of general information remains the same regardless of whether the submittal project has been created for a single RI or a system of RIs. For the rest of the submittal project configuration, however, there is a difference between a system submittal project and a single RI submittal project. In particular, since a system submittal project contains multiple RIs, the configurator 46 allows the set of information that is presented in the following sections to be collected for each RI in the system. When the save and next input 100 is clicked, the information entered into the User Selection page 94 is saved and the next page is presented to the user.

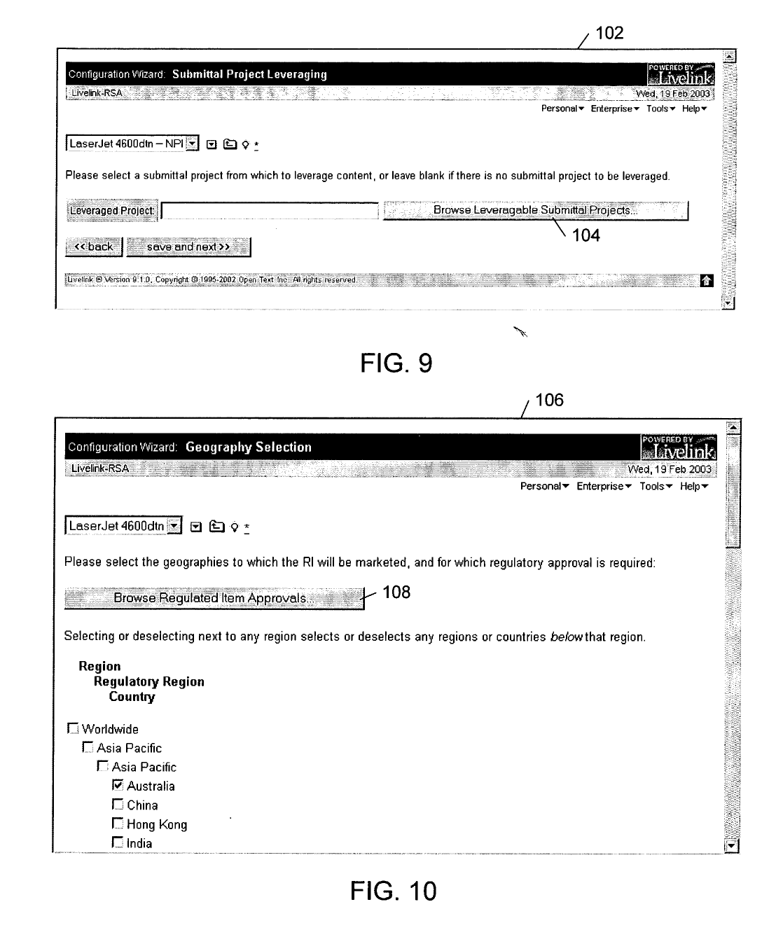

Referring to FIG. 9, a Submittal Project Leveraging Page 102 prompts a user to select an existing SP, if any, a current submittal project will leverage content from. By clicking the Browse Leveragable Submittal Projects button 104, the user may select any other SP which:

Is complete, AND

Is associated with:

an RI from the user's PGO, OR

any RI for which his or her PGO is an Acknowledged Partner Division (APD), OR

a System which contains an RI either from the user's PGO or for which the user's PGO is an APD

When a user creates a system submittal project, the user is able to apply the leverage functionality to each RI that is part of the system. In other words, if the system consisted of three RIs, the user may choose to leverage components from a previously completed SP for each of these RIs. Note that each RI in the system may leverage from a different SP (i.e., each RI may leverage a specific RI from a selected SP).

Referring to FIG. 10, a Geography Selection page 106 prompts a user to select one or more geographies to which the current RI will be marketed and for which regulatory approval is required. If a geographical region is selected or deselected, then all the geographies (e.g., countries) underneath that region are correspondingly selected or deselected. A Regulated Item Approval browser is available by pressing the Browse Regulated Items Approvals button 108 to display any Approval Objectives that have already been certified for this Regulated Item.

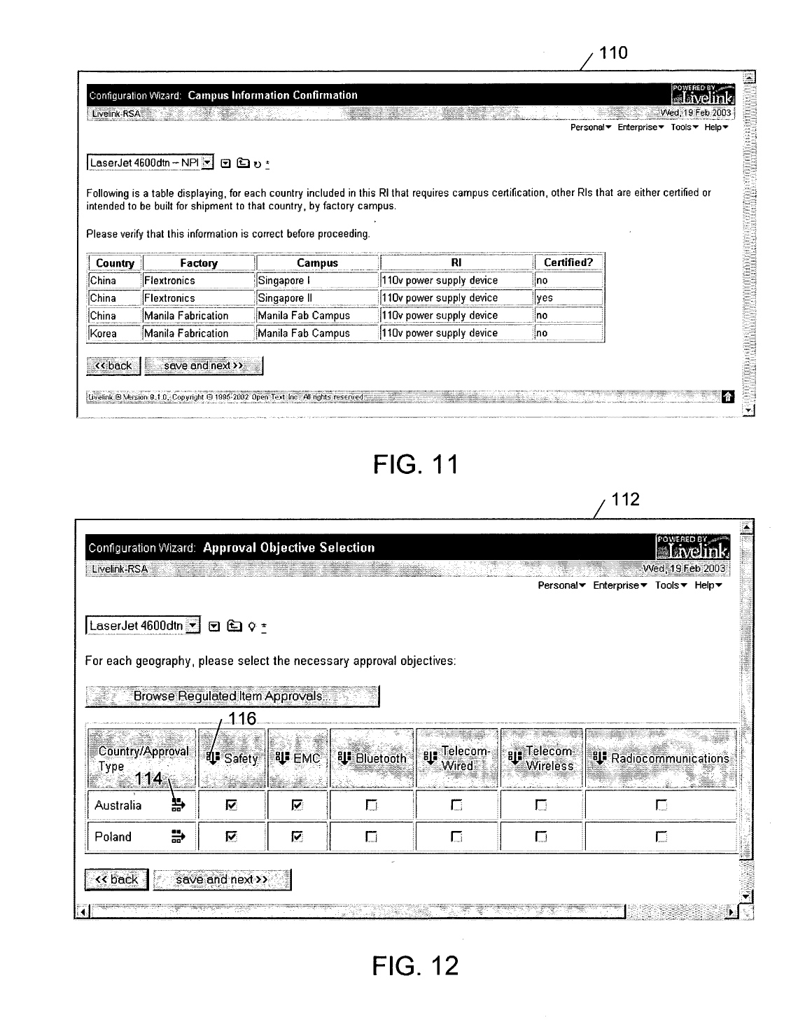

Referring to FIG. 11, a Campus Information Confirmation page 110 displays, by factory campus, other RIs that are either certified or intended to be built for shipment to a country for each country included in a current RI that requires factory certification. This information is obtained from reference data, including the following information:

Which campuses are intended to build which RIs for shipment to which geographies

Which geographies require campus certification

Which factories are certified to ship which RIs to which geographies

Once the target geographies are selected for a submittal project, campus certification information may be displayed to the user. Since all campus/RI/certification information is in reference data, the purpose of this page is simply to allow the user to confirm that the reference data is set up correctly for the current RI.

Referring to FIG. 12, an Approval Objective Selection page 112 displays a matrix having rows and columns. The rows include all previously-selected geographies that have approval objectives defined in reference data. The columns include all approval types selectable for the set of geographies displayed in the rows. At the intersection of each geography row and approval-type column, a checkbox appears if that approval type is defined as an approval objective for the corresponding geography. “Toggle” buttons 114, 116 appear next to the row and column labels to enable the user to easily make selections of every checkbox either in a geography row or approval type column. Pressing these buttons will alternately select or deselect all the checkboxes in the corresponding row or column.

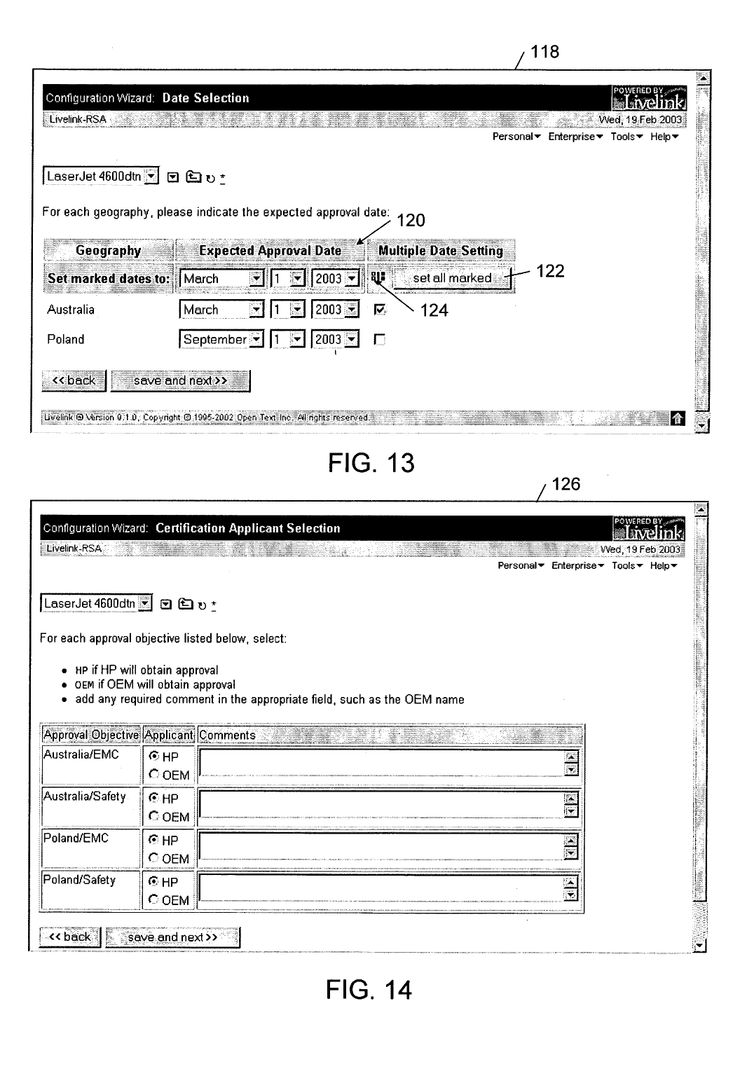

Referring to FIG. 13, a Date Selection page 118 prompts a user to indicate the expected approval date for each geographic location that was selected. For every geography that has had at least one approval objective selected for it, this page allows the user to select an expected approval date using a standard Livelink® date selector. To allow the user to easily set several geographies to have the same expected approval date, the user may select checkboxes to the right of each date selector, and then use the master date 120 above and the set all marked dates button 122 to quickly set all the geography dates to the master date. A toggle button 124 at the top of the screen allows the user to quickly select all or none of the geography dates for “quick-setting.”

Referring to FIG. 14, a Certification Applicant Selection page 126 displays a list of the SP's approval objectives. For each approval objective, the user may enter:

The Applicant who will obtain the approval objective's certification.

Comments in the form of a free-form text note, where the user may make notes about which OEMs will obtain which approval objectives. These notes will be visible to TRSEs.

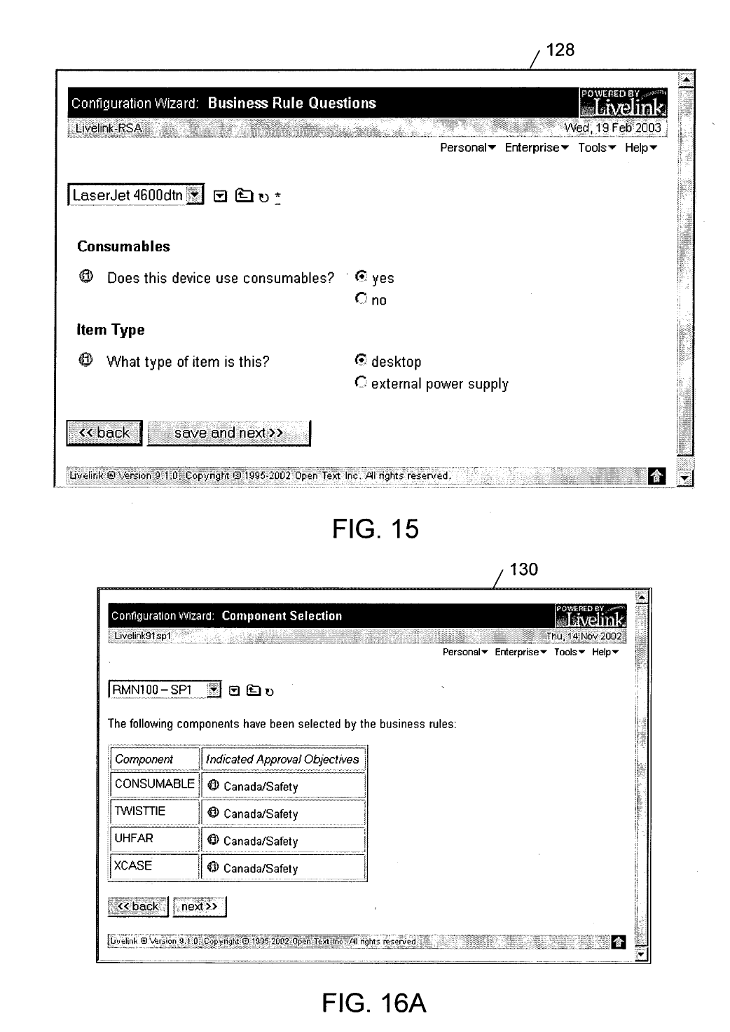

Referring to FIG. 15, a Business Rule Questions page 128 presents the user with a series of questions about the submittal project. At this point, the system has amassed a series of facts about this project: Project-type, Approval-scope, Product, Country, and Approval-type information. These facts will fire off predefined business rules, and some of these business rules will cause questions to be asked. The system will ask as many questions as possible per page. When these questions are answered, more facts will be asserted about the project, and these facts may in turn cause more questions to be asked. This interrogation happens as many times as required by the business rules, and stops when the business rules state that there are no more questions to be asked. Some questions are answered only once for the entire SP. Some questions require an answer for each country targeted in the SP.

After all the business rule questions have been answered, the configurator 46 knows which components have been indicated for which approval objectives. This information is displayed on a Component Selection page, which has a format that depends on the context.

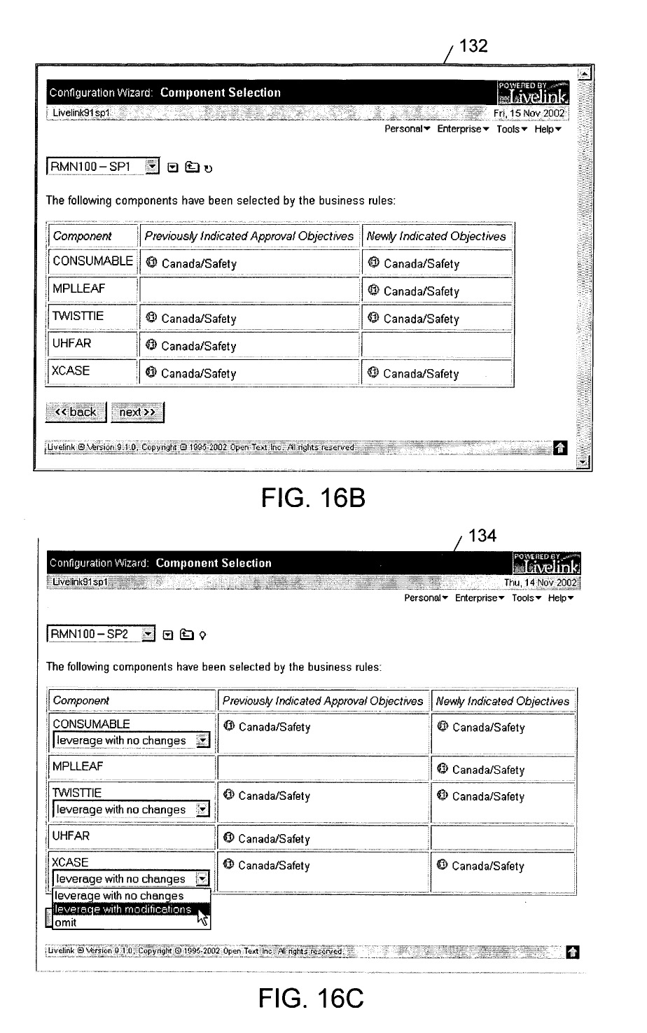

Referring to FIG. 16A, in one example, a Component Selection page 130 identifies the components that have been selected by the business rules for a new, non-leveraged SP that is being configured. The illustrated example corresponds to submittal project RMN100--SP1, which is a new, non-leveraged SP created for RMN-100. After configuration, the component selection list may include the components and approval objectives shown in FIG. 16A. Since RMN100--SP1 is not leveraged and has no previous versions, there is no before-and-after view of the components. Accordingly, Component Selection page 130 only displays which components will be included for which approval objectives when this SP is generated. At this point, the SP has the current project configuration and is ready to be generated. When the PGO initiator runs the generator, the appropriate components are copied from the submittal component library and the appropriate SP objects are set up. After being generated, the project configuration is stored as PCv1 in the SP's version history.

Referring to FIG. 16B, in another example, a Component Selection page 132 identifies the components that have been selected by the business rules for a reconfiguration of an existing submittal project. The illustrated example corresponds to a reconfiguration of the project of FIG. 16A, where some of the business information about the RMN100-SP1 submittal project has changed. The PGO user invokes the configurator by selecting the “Configuration Wizard” function on RMN100-SP1. In some embodiments, the configurator notices that there is no project configuration currently in progress. Accordingly, it begins the wizard process from the beginning. That is, the configurator creates the new PC version completely from scratch: the user is not actually “editing” the previously generated PC. However, for this second run-through of the configurator, each wizard page loads the answers from the previous version (i.e., PCv1) as defaults. In this way, it appears to the user that he or she is modifying the previous version. In some embodiments, the user still needs to start from the beginning of the wizard, and follow it through all the way to the end, changing the answers on the pages as appropriate.

In the illustrated example, the user has changed some business rule answers regarding radio emissions and maple leaf decals, and leaves all the other pages as they appear by default. The resulting Component Selection page 132 may appear as shown in FIG. 16B. In this example, a before-and-after view is displayed, with the last version of the project configuration in the second column, and the new version of the project configuration in the third column. In this case, when the new PC is generated, a MPLLEAF component is added to the submittal project (for the Canada/Safety approval objective), and the UHFAR component is no longer required for the submittal project. After the generator is invoked on this project configuration, the project configuration is stored as PCv2 in the submittal project's versions folder.

Referring to FIG. 16C, in another example, a Component Selection page 134 identifies the components that have been selected by the business rules for a submittal project that leverages an existing submittal project. The illustrated example corresponds to a submittal project that leverages the submittal project of FIG. 16B, where RMN-100 has another submittal project (RMN100-SP2) created for it. When the PGO initiator creates this submittal project, PGO initiator selects “RMN100” as the RMN and “RMN100-SP1” as the project from which to leverage content. While stepping through the configurator wizard pages, the configurator presents, as defaults, the answers from the most recently generated version of the leveraged submittal project. At the end of the configuration, the configurator will present a before-and-after look at the components and approval objectives that have been selected. The “before” column will contain the components and approval objectives from the most recent version of the leveraged submittal project's submittal project, and the “after” column will contain the components selected during the current configuration run.

In some embodiments, for each component that is indicated in both the leveraged project and the new project, the user will have three options with regard to component leveraging:

leverage with no changes: the user chooses to copy the leveraged project's version of the component, which automatically sets the new version with the status “Completed”.

leverage with modifications: the user chooses to copy the leveraged project's version of the component, and which automatically sets the new version's status to “Not Completed”.

omit: the user chooses not to leverage the component, and the system simply copies it from the submittal component library, and which automatically sets its status to “Not Completed”.

In some of these embodiments, these component-leveraging options are only presented to the user the first time a new, leveraged submittal project is configured. Subsequent reconfigurations show the same before-and-after view as would appear when reconfiguring a non-leveraged submittal project. If user decides to leverage content at a later time (after the initial configuration of the submittal project), he or she must copy-and-paste within an In-Process Project Manager (IPPM) area—the configurator will not copy the content for the user.

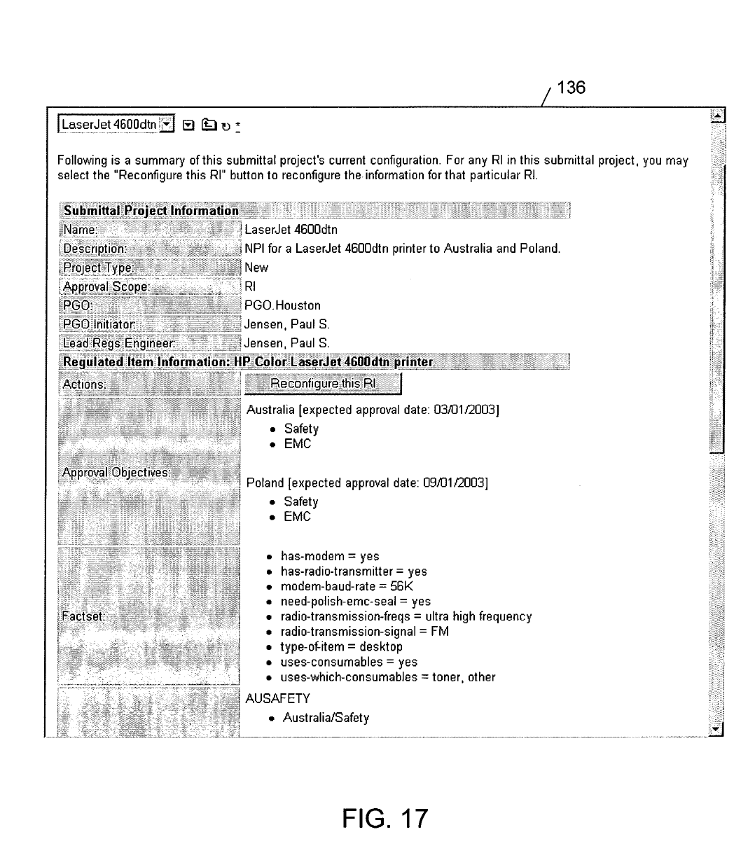

Referring to FIG. 17, after the Configurator has collected all the required information, a summary page 136 is presented to the user to allow him or her to verify that all the information is correct.

2. Generating A Universal Submittal Package

Referring back to FIG. 6, after a submittal project has been configured and the user has verified that all of the information is correct, a Generate function may be invoked from the Functions dropdown menu to apply the information in the newly-configured project configuration to the submittal project and to store the project configuration as a Livelink® version. After the Generate function has been invoked, the universal submittal package configurator 46 passes the resulting projector configuration object to the submittal page generator 48, which creates a universal submittal package by matching approval objectives to submittal components in the submittal component library (step 140).

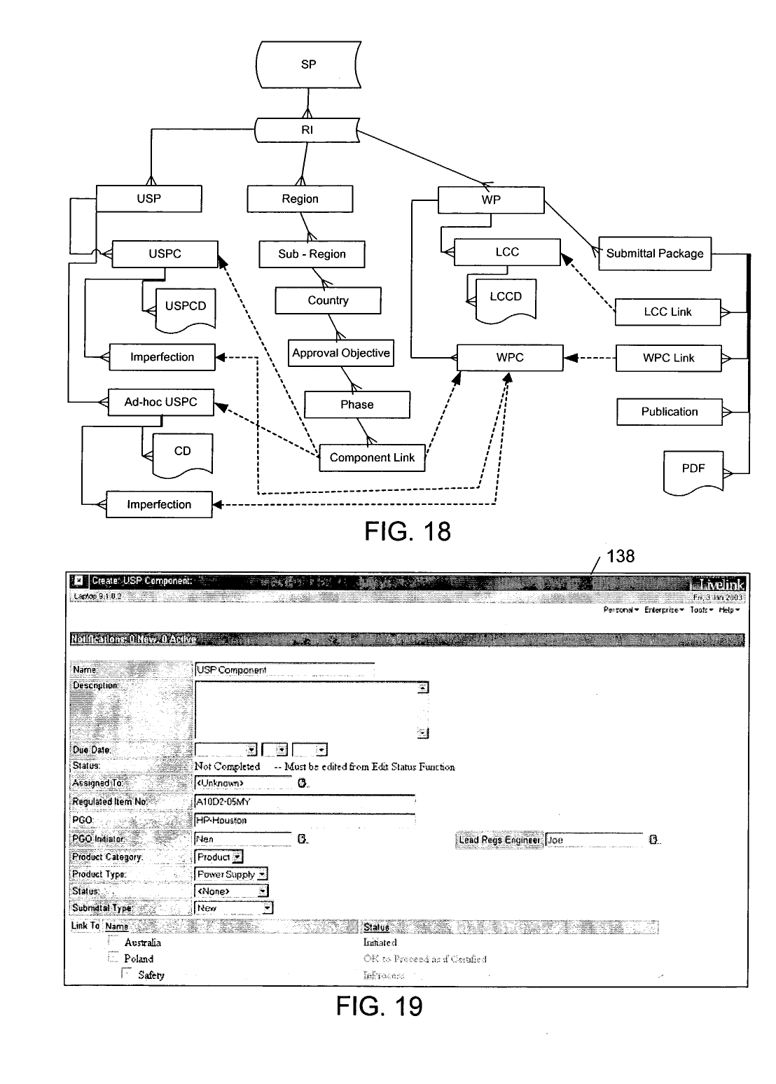

The submittal project generator 40 provides the functionality to generate the structure of a submittal project. The submittal project generator 40 component actually works “behind the scenes,” and is activated when the PGO chooses the Generate option on the Summary page 136 of the configurator 46. The submittal project generator 40 then generates the required object hierarchy in the submittal project. In essence, this will “initiate” the submittal project and “start the clock” on all the tasks and milestones in the project. In some embodiments, submittal project generator 40 generates a submittal project populated with objects having the relationships shown in FIG. 18, where a dotted arrow denotes the association one object has with another object. In the illustrated embodiments, these objects are custom Livelink® objects with the following properties:

a. Submittal Project (SP)

This object started as the Task List object, and is extended to include the basic functionality described above. The SP is the parent container object of all the other objects and is created by the Submittal Project Generator (SPG). One PGO representative (PGO initiator) configures a SP.

b. Regulated Item (RI)

This object is used to group approval objectives associated with each regulated item in a submittal project.

c. Universal Submittal Package (USP)

This object is used to group the universal components compiled by the SPG for an RI.

d. Universal Submittal Package Component (USPC)—also used for Ad hoc USPC

This object provides the functionality of Releases to facilitate the concept of a release of a component (USPC). Since a USPC can contain multiple component documents (USPCDs), references to each individual document version number became undesirable. The concept of a release allows all the USPCDs to be treated as a unit and a single reference to the release facilitates access to that specific release of the content.

e. Component Document (USPCD)

This object provides a way to identify the content, or templates from other attachments accompanying the component, namely collateral documents such as examples and/or instructions was necessary. Rather than carrying metadata that made this distinction a different object allows this identification of content vs. non-content to be made much easier. Additionally the Release functionality of the USPC has been modified to include in the release only USPCD and not any non-content attachments.

f. Imperfection

This object provides the mechanism to track each imperfection reported by each TRSE for a specific USPC. An Imperfection object is created dynamically for each imperfection reported by each TRSE. It will exist as a child object of the USPC object.

g. Region and Sub-Region

This object provides the grouping of region, sub-regions, and countries. It is a view designed mainly for the PGO initiator and lead Regs Engineer.

h. Country

This object allows each country's approval objective and their statuses to be grouped and tracked.

i. Approval Objective

This object is an assembly of USPCs that are required for a submittal to an agency (as defined by the country and approval type combination). The main purpose of this object is to track status of approvals.

j. Phase

This object is a container for Component Link objects (described below) and will allow the re-evaluation of the status at a Phase level as the subordinate Component Link object change status. The three phases are Pre-submittal, Required Now, and Post-Submittal. The main purpose of this object is to group and track each Component Link object and their statuses. It is a view designed mainly for the PGO initiator and lead Regs Engineer. When all the components in a Phase is completed by the Regs Engineers the PGO initiator or lead Regs Engineer can release all the submittal components in this Phase to the TRSE for review. USPCs marked as optional are included in the appropriate phase. Logic for releasing the phase to the TRSE prevents the phase from being released if any required USPCS have a status of “Not Completed”, but allows the phase to be released if any optional USPCs have a status of “Not Completed”.

k. Work Package (WP)

This object is an assembly of universal components released by the PGO. A WP is defined in terms of country and approval type combinations defined by the lead TRSE of each region (to be defined in Reference Data). In this view the released USPC objects are referenced as WPC objects. This grouping within the WP of WPC objects serves to provide the lead TRSE a unique view of the WPCs. The assignment of a lead TRSE to this object will allow this object to be visible in the Personal Assignments list of the lead TRSE. At which point the lead TRSE will have the capability to assign individual WPCs and Submittal Packages (see description below) to other TRSEs. By default, the WPCs and Submittal Packages are all assigned to the lead TRSE of the WP.

l. Work Package Component (WPC)

This object may be associated through the Component Link object to the specific release of a USPC that contains the content of this WPC. This object will record and lock-down the specific release number of the USPC that is associated with this WPC object when this WPC is flagged as “Work in Review” by the TRSE. WPC objects are assigned to TRSEs as task items.

m. Work Package Local Content Component (LCC)

This object is based on the USPC object described previously. Its intention is to be used as the container of any local content (documents) that a TRSE would like to have as part of the WP.

n. Work Package Local Content Component Document (LCCD)

This object is based on the same object as the USPCD object. In this case this object is the document (file) that provides local content for submittals and is added by the TRSE and managed at the WP level. LCCD objects have the same format and share the same object as USPCD.

o. Submittal Package

This object is intended to be the container of locked down (“frozen”) releases of WPC and LCC objects (represented as WPC Link and LCC Link objects respectively) that have been assembled by the TRSE. It contains the Publication objects that will control the creation of specific PDF files from subsets of the WPCs or LCCs identified as part of this Submittal Package.

p. Component Link, LCC Link, WPC Link

The Component Link is the object that identifies which USPCs are part of the parent Phase object, contains a pointer to the USPC and contains a pointer to the WPC in the Work Package. LCC Link and WPC Link objects identify the components, either the LCC or WPC respectively that are contained in the parent Submittal Package object. The use of these objects will not be noticeable to the end users since these objects will have the name of the component it represents (e.g. Declaration of Safety). It is mainly used by the system to track the statuses of these components in different work packages.

q. Publication

This object contains the set of selected documents that need to be transformed into a single PDF file through the publishing mechanism. Agents that are part of the Publication module cause the transfer of created PDF files located in the same folder as the Publication object.

r. PDF

This is the PDF document created by the Publication function. It is the document that can be sent to the regulatory agency for approval.

s. Approval Notification

This object is created as a result of changing the status of a Work Package Submittal Package object to a status indicting Transmission, Approval, Rejection or the receipt of a Certificate related to a specific Approval Objective. There is one Approval Notification object per approval objective in the Submittal Package.

In one exemplary illustration of the submittal package population process, assume there is the following business rule: If the approval objective=Mexico-safety, then add universal submittal package component “CB Report” to submittal project. In the submittal component library, universal submittal package component “CB Report” is defined as being a required component for the “now” phase for all approval objectives. Suppose a new submittal project is initiated, with Mexico-safety as one of the approval objectives. During the universal submittal package creation process, the universal submittal package component “CB Report” is added to the submittal project in the following hierarchy:

Latin America Region

Mexico

Mexico-safety

“Now” phase

CB Report

Referring to FIG. 19, in some embodiments, after the submittal project has been configured and generated, the PGO initiator or lead Regs Engineer for that submittal project may decide to include ad-hoc components that were not included in the project by business rules. These ad-hoc components may be associated with appropriate approval objectives. An ad-hoc USPC component may be added manually. The USP object will have the option from its Add New Item menu to add an Ad-hoc Universal Submittal Package Component (USPC). The PGO initiator or lead Regs Engineer may use this function to create an ad-hoc component in the current submittal project using a Create: USP Component page 138. If changes need to be made to the configuration information, the user may go back to the appropriate page to change it.

Submittal projects may be initiated by the PGO months before components and work packages are released to the TRSE for review. During this period, new approval objectives may be required for approvals in the regions or countries the product is marketed in. These new approval objective(s) may be included in the in process submittal project and in the applicable work package(s) that are managed by the TRSEs. The new approval objectives are added to the reference data tables and the business rules will be defined for the new component. The lead TRSE updates his/her work package with this new approval objective in reference data. In addition, the PGO initiator may update the Due Date column for each Country in the RI. This will cause the “Due Date” (Transmit-By date) for “Required Now” phase of each approval objective for each country to be re-calculated. The Planned Completion date will be re-calculated when the TRSE has accepted all “Required Now” components. If the “Due to Delay” checkbox is checked, every approval objective will have a status set to “Suspended by PGO” and the Planned Completion date for each approval objective will be re-set to nil.

When the PGO is ready to start the process again, he/she will set each approval objectives' status to “Resume Review”. The planned completion date will be calculated when the TRSE has received and accepted all the updated “Required Now” components, and the approval objective's status will be set to “In Process”.

The TRSE may manually change the planned completion date attribute for each approval objective. A scenario when this may happen is when the TRSE wants to expedite the approval from the regulatory agency and the agency has agreed to the new date. In this scenario, in addition to changing the planned completion date, the TRSE marks a checkbox attribute beside the planned completion date to indicate that this planned completion date is now an expedited date. The expedited flag will exclude this date from skewing the statistics.

A PGO may cancel (withdraw) the entire submittal project, withdraw a country from a RI project, or withdraw an approval objective in a country from the RI. In these situations the approval objectives associated with the withdrawn submittal project or country will have a status of “Cancelled” set to it. This will exclude this instance of the approval objective from the statistics.

2. Managing A Submittal Package Workflow

The In-Process Project Manager 44 (FIG. 3) provides the functionality to manage the Submittal Project from start to finish. That is, from the time the Product Generation Organization (PGO) creates the SP to when the product is approved (or rejected) by the country specific agencies. As explained above, a submittal project involves two groups of individuals:

PGO and Regs Engineer group

Regional TRSE groups

Each group has specific tasks and functions they must perform to achieve the goal of obtaining regulatory approval for the product. Some of the tasks the PGO/Regs Engineer perform include:

Configure, create, modify and initiate a submittal project with the Universal Submittal Project Engine 40

Leverage content from other projects

Designate a lead Regs Engineer to the submittal project

Provide content to the universal components

Add ad hoc USP component

Assign other Regs Engineers to provide content to the universal components

Create new Release versions of universal components

Update the statuses of the SP and USPCs

Release USPCs at the phase level

Acknowledge and correct imperfections reported by TRSEs

Searches

As explained above, the PGO initiator runs the universal submittal package configurator 46 and initiates the submittal project. The universal submittal package configurator will invoke the submittal package generator to create the submittal package object in the Livelink® repository. The initial status of the submittal package will be set to “In Process” and will be assigned to the PGO initiator. Each universal submittal package component in the submittal package will also be a task item assigned to the lead Regs Engineer. The universal submittal package component tasks will show up in a Personal Assignments list of the lead Regs Engineer as task items. Only the submittal component item will show up in the Personal Assignments list of the PGO initiator.

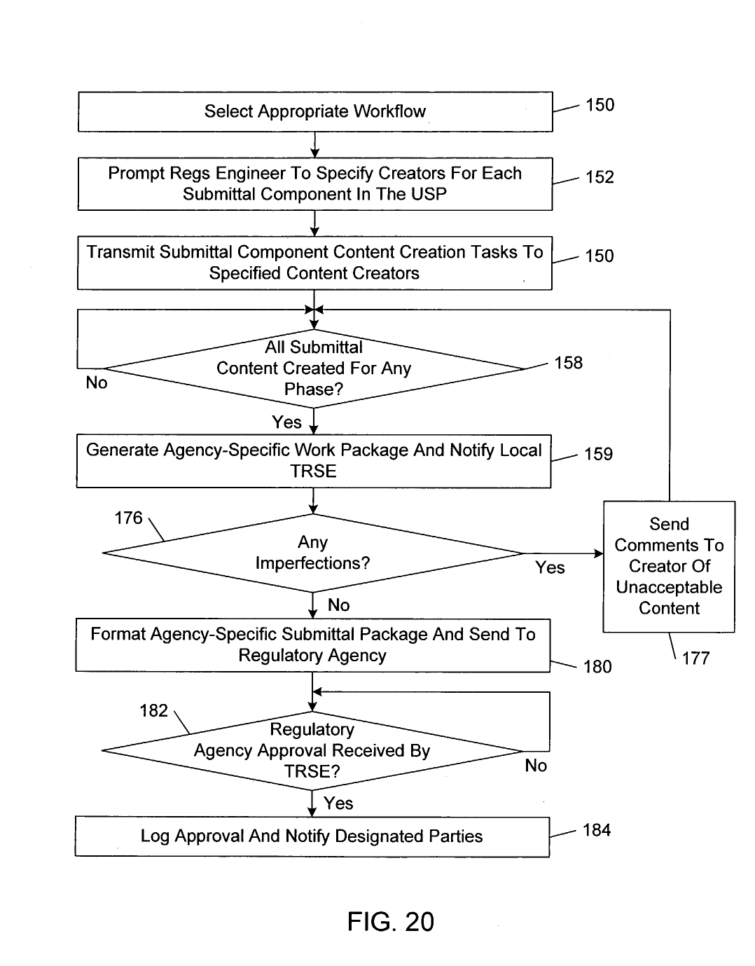

Referring to FIG. 20, in some embodiments, in-process project manager 44 may manage and transfer regulatory information between the Regs Engineer and one or more TRSEs as follows. Initially, in-process project manager 44 selects an appropriate workflow (e.g., new project or renewal) based on the inputs received from the Regs Engineer (step 150). The workflow governs the overall project as well as the individual tasks and submittal components.

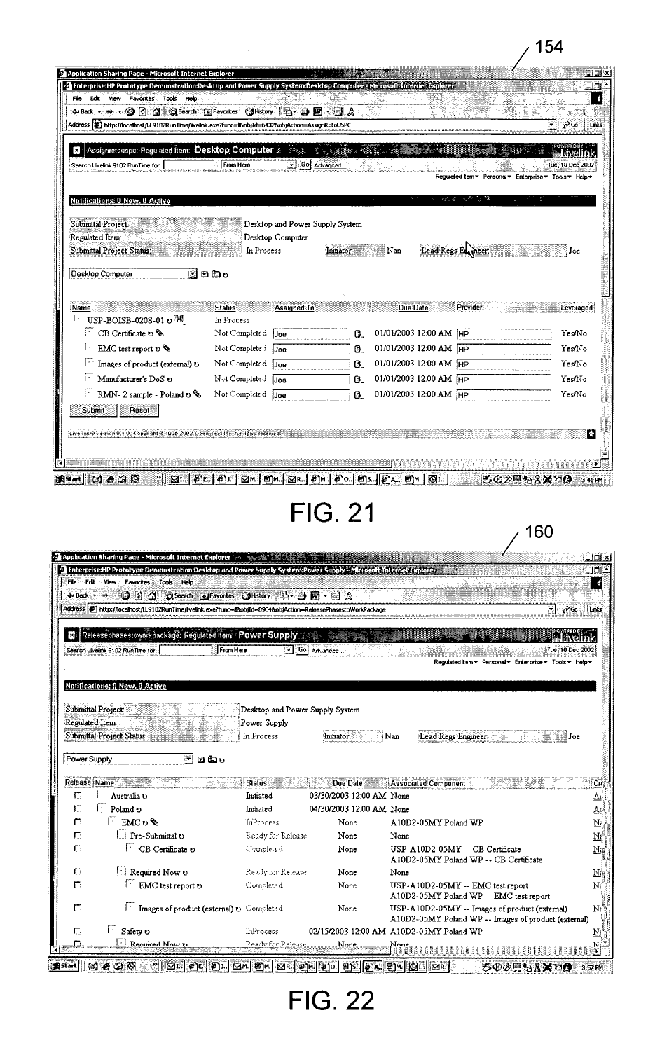

Referring to FIGS. 20 and 21, in-process project manager 44 prompts the PGO initiator or lead Regs Engineer to specify creators for each submittal component in the universal submittal package (step 152). For example, the PGO initiator or lead Regs Engineer can assign Universal Submittal Package Components (USPCs) to other Regs Engineers to complete. To facilitate this activity, the USP object has a function named “Assign USPC” from its drop down Functions menu. When the PGO initiator selects this function an assignment screen 154 is displayed. Assignment screen 154 allows the PGO to assign work to the Regs Engineers.

After the submittal component creation tasks have been assigned to at least one creator, the in-process project manager 44 transmits the submittal component content creation tasks to the specified content creators. Once a USPC is completed, the Regs Engineer can update the status of that USPC to “Complete” (or “Not Provided” or “En Route”). This is accomplished by selecting the Update Status function from the drop down Function menu for the USPC. If this was the first time a Release was created for this USPC, a Release version 1.0 is assigned automatically to this USPC. The Release number is applied to the USPC as a whole. The release version also may be set manually. To facilitate this, a function called Create Release is available in the drop down Functions menu of the USPC object. The Regs Engineer can give this release any name they wish. In the Description field, they can enter the Headline information regarding this release. After the status of the USPC has been changed to “Completed” (or “Not Provided” or “En Route”), this in turn automatically may change the status of the Phase object (Pre-Submittal, Required Now, or Post-Submittal) in which this USPC belongs.

If all the USPCs for a particular phase are completed (step 158), the status of the Phase object is set to “Ready for Release”. In response, the in-process project manager 44 will send a custom notification to the PGO initiator that a particular phase can be released (step 159).

Referring to FIG. 22, after the PGO initiator has been notified that a phase is ready for release, the PGO initiator may release the phase through a user interface 160, which includes options for releasing multiple phases simultaneously. In response to an indication by the PGO initiator to release a is phase, the in-process project manager 44 generates an agency-specific submittal work package and notifies the lead TRSE responsible for reviewing the work package (WP). Once released, each USPC in the Phase is assigned to the lead TRSE responsible for the work package associated with the USPCs released. The USPCs in the WP are referenced as WPC objects. The WPCs are task items that initially are assigned to the lead TRSE and will appear in their Personal Assignments list.

Some of the tasks the TRSEs performs include:

Review content of components released by PGO

Update the status of components released to them

Report imperfections

Subscribe/un-subscribe to imperfections and corrections

Assemble and modify submittal packages

Assign other TRSEs to review content and to manage submittal packages

Provide local content to the submittal packages

Create a PDF publication to send to the regulatory agency or test lab.

Record approval notifications from the agencies. (This can also be done by PGO role)

Set certification at the country level once all approval objectives are met in that country

Manage certificate renewals and expirations

Searches

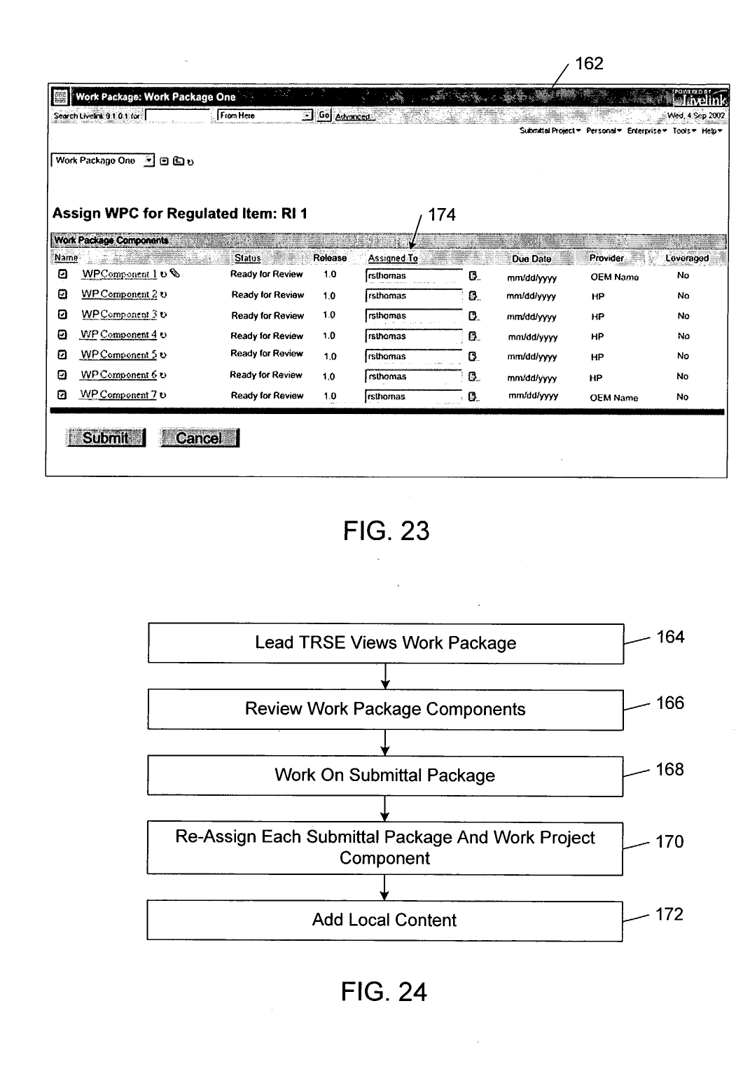

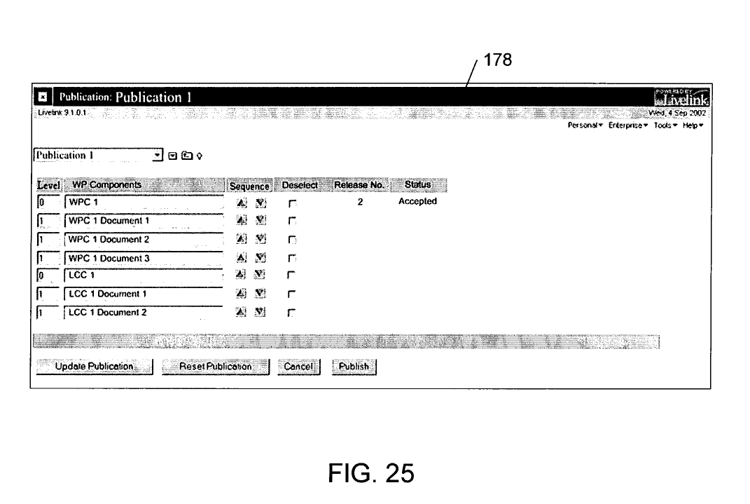

Referring to FIGS. 23 and 24, once the components are released by the PGO, the lead TRSE's WP and released components (WPCs) will appear in his/her Personal Assignments list 162 as individual task items (step 164). The lead TRSE can select the WP object to see the contents of his work package or he/she can select each component in the assignments list to review (step 166). The work package is pre-assembled by the submittal project generator 44 from reference data information.

From Personal Assignments page 162 the lead TRSE can:

Work on the submittal package (step 168). For example,

Update status of Submittal Packages via the drop down Functions menu

Update status for region/sub-region/country via the drop down Functions menu associated with the work package item. Everything should be looked at from a Regional to Country perspective

Create Submittal Packages via the Add New Item menu and selecting WPCs in the WP

Change planned completion date for each approval objective

Re-assign each WPC and Submittal Package to other TRSEs for review (step 170)

Add local content, such as application forms in the local language, into the Submittal Package object (step 172)

To assign WPCs to other TRSEs to review, the lead TRSE may use the function Assign To 174 from the WP object Functions menu. From this interface, the lead TRSE can assign an individual or group name from the Livelink® system to review each WPC. If a group name is selected, the WPC will be visible in the Personal Assignments list of everyone in that group. By default, the name of the lead TRSE will be assigned to all the WPCs. Once all the WPCs have been assigned, the lead TRSE clicks the Submit button to save the settings. At this point, each WPC will appear as a task in the Personal Assignments list of the TRSE who have been assigned to review a WPC. The screen then returns to the previous screen where this function was initiated.

Similarly, the lead TRSE can assign other TRSEs to manage Submittal Packages he/she has created. This is accomplished by using an Assign TRSE to Submittal Packages function. The corresponding view will look similar to the view used to assign WPC to TRSEs as on the Personal Assignments list 162. However, there will be less information displayed. This view will mainly consist of the list of submittal packages and the ability to assign a user or group name to each submittal package. Once a submittal package has been assigned to another TRSE the submittal package will appear in that TRSE's Personal Assignments list as a task item.

If there are any imperfections in the work package (e.g., material is incomplete or missing) (step 176), the lead TRSE may transmit comments to the creator responsible for the imperfection (step 177; FIG. 20).

Referring to FIGS. 20 and 25, once the lead TRSE is satisfied with all the content of the submittal package (step 176), he/she can lock-down (“freeze”) the contents so that all the releases of the components become unchangeable . To facilitate this, a function named Lock Down is available from the Functions menu of the Submittal Package object. When the submittal package is “ready”, the TRSE selects Create Publication Object from the Add New Item menu to create the publication to send to the regulatory agency (or just for self filing in the case of self declarations). The name of the publication may be entered manually by the TRSE and typically should reflect the agency it is meant for. A Publication screen 178 presents functions that allow the TRSE to select the WPCs and LCCs to publish and the order in which they will appear in the publication. The publication is formatted into a prescribed format (e.g., in a PDF output file) and transmitted to the designated regulatory agency (step 180). Once the PDF publication has been generated, the TRSE can provide invoice information regarding the transmission of this publication to the regulatory agency by using the Approval Notification form.

After approval has been received from the regulatory agency for a specific approval objective (step 182), the lead TRSE records the Approval Notification for that specific approval objective (step 184). This is done by using the Add New Item menu to add the Approval Notification Object to the approval objective object. Clicking the Approval Notification Object allows the TRSE to view the Attributes and enter all metadata information for this approval. If the agency also sends a Certificate of Approval, that document (converted to electronic format if necessary) may be added to the Regulated Item object as well via the Add New Item menu in that object. Once a specific approval objective has been met either through approval from the agency or via self-declaration, the TRSE can update the status of the submittal package to “Approved”. This will automatically update the status of the associated approval objective to “Approved”. The PGO can also complete the Approval Notification form, add a Certificate of Approval, and update the status of the approval objective from the SP object view.

When the status of any approval objectives for a country has changed, the system will evaluate all other approval objectives for that country. If they are all approved then a notification will be sent to the lead TRSE that this particular country has met all approval objectives. The lead TRSE can then open up his/her work package and set the status of that country to “Certified”. This in turn will send a notification to the PGO initiator of the submittal project that this country has certified the product and it is OK to ship it there.

Other embodiments are within the scope of the claims.

What is claimed is:

1. A method of managing regulatory information, comprising:
accessing a library of submittal components each specifying respective submittal content;
querying the submittal component library based at least in part on information relating to a regulated product and at least one regulatory approval objective, wherein each approval objective specifies a compliance approval type and a target market in which the product is regulated; and
based on the submittal component library query, generating a universal submittal package comprising a set of submittal components for generating at least one submittal package.

2. The method of claim 1, wherein the library comprises submittal components each respectively identifying at least one of the following content types: documents, forms, test reports, photographs, and physical item shipment records.

3. The method of claim 1, wherein submittal components in the library are linked to approval objectives.

4. The method of claim 1, further comprising prompting a user to specify information relating to a regulated product, at least one compliance approval type, and at least one target market in which the product is regulated.

5. The method of claim 4, wherein the product information includes an identification of at least one regulated item incorporated in the product.

6. The method of claim 4, wherein the at least one compliance approval type information includes an identification of at least one of an electromagnetic compliance approval, a safety compliance approval, and a telecommunications compliance approval.

7. The method of claim 4, wherein the target market information includes an identification of at least one country or region for which a submittal package for the product is to be created.

8. The method of claim 4, wherein generating the universal submittal package comprises matching user-specified information to submittal components in the library.

9. The method of claim 4, wherein the universal submittal package comprises a set of submittal components sufficient to address all approval objectives specified by a user for a submittal project.

10. The method of claim 1, further comprising managing a workflow for collecting submittal content specified by the submittal components of the universal submittal package.

11. The method of claim 10, wherein managing the workflow comprises selecting a workflow based on a user-specified submittal project type.

12. The method of claim 11, further comprising prompting a user to specify one of the following submittal project types: a new submittal project, a renewal submittal project, a re-certification submittal project, and an update approval submittal project.

13. The method of claim 10, wherein managing the workflow comprises collecting submittal content corresponding to one or more of the following contents: documents, forms, test reports, photographs, and physical item shipment records.

14. The method of claim 10, further comprising prompting a user to specify one or more creators of submittal content to be collected.

15. The method of claim 14, further comprising assigning submittal content creation tasks to each of the user-specified creators.

16. The method of claim 15, wherein each content creation task includes a specification of submittal content selected based on at least one regulatory item incorporate in the product.

17. The method of claim 10, further comprising generating an agency-specific work package comprising submittal content corresponding to a subset of the submittal components of the universal submittal package linked to a given approval objective after all submittal content specified for the given approval objective has been collected.

18. The method of claim 17, further comprising notifying a local regulatory representative in the given target market that a completed agency-specific work package is available for review.

19. The method of claim 18, further comprising transmitting to one or more submittal content creators comments by the local regulatory representative relating to changes for corresponding submittal content contained in the agency-specific work package.

20. The method of claim 18, further comprising formatting the agency-specific work package into a submittal package having a pre-specified format.

21. The method of claim 20, further comprising logging a notification of regulatory compliance approval after receiving an indication from a regulatory agency that an approval objective of the submittal package has been approved.

22. A computer program for investigating a business process, the computer program residing on a computer-readable medium and comprising computer-readable instructions for causing a computer to:
access a library of submittal components each specifying respective submittal content;
query the submittal component library based at least in part on information relating to a regulated product and at least one regulatory approval objective, wherein each approval objective specifies a compliance approval type and a target market in which the product is regulated; and
based on the submittal component library query, generate a universal submittal package comprising a set of submittal components for generating at least one submittal package.

23. A system for managing regulatory information, comprising a universal submittal package engine operable to:
access a library of submittal components each specifying respective submittal content;
query the submittal component library based at least in part on information relating to a regulated product and at least one regulatory approval objective, wherein each approval objective specifies a compliance approval type and a target market in which the product is regulated; and
based on the submittal component library query, generate a universal submittal package comprising a set of submittal components for generating at least one submittal package.

24. The system of claim 23, wherein the universal submittal package engine is operable to prompt a user to specify information relating to a regulated product, at least one compliance approval type, and at least one target market in which the product is regulated.

25. The system of claim 24, wherein the product information includes an identification of at least one regulated item incorporate in the product.

26. The system of claim 24, wherein the compliance approval type information includes an identification of at least one of an electromagnetic compliance approval, a safety compliance approval, and a telecommunications compliance approval.

27. The system of claim 24, wherein the target market information includes an identification of at least one country or region for which a submittal package for the product is to be created.

28. The system of claim 24, wherein the universal submittal package engine is operable to generate the universal submittal package by matching user-specified information to submittal components in the library.

29. The system of claim 23, further comprising an in-process project management engine operable to manage a workflow for collecting submittal content specified by the submittal components of the universal submittal package.

30. The system of claim 29, wherein the in-process project management engine is operable to select a workflow based on a user-specified submittal project type.

31. The system of claim 30, wherein the in-process project management engine is operable to prompt a user to specify one of the following submittal project types: a new submittal project, a renewal submittal project, a re-certification submittal project, and an update approval submittal project.

32. The system of claim 29, wherein the in-process project management engine is operable to collect submittal content corresponding to one or more of the following contents: documents, forms, test reports, photographs, and physical item shipment records.

33. The system of claim 29, wherein the in-process project management engine is operable to prompt a user to specify one or more creators of submittal content to be collected.

34. The system of claim 33, wherein the in-process project management engine is operable to assign submittal content creation tasks to each of the user-specified creators.

35. The system of claim 29, wherein the in-process project management engine is operable to generate an agency-specific work package comprising submittal content corresponding to a subset of the submittal components of the universal submittal package linked to a given approval objective after all submittal content specified for the given approval objective has been collected.

36. The system of claim 35, wherein the in-process project management engine is operable to notify a local regulatory representative in the given target market that a completed agency-specific work package is available for review.

37. The system of claim 36, wherein the in-process project management engine is operable to transmit to one or more submittal content creators comments by the local regulatory representative relating to changes for corresponding submittal content contained in the agency-specific work package.

38. The system of claim 36, wherein the in-process project management engine is operable to format the agency-specific work package into a submittal package having a pre-specified format.

39. A method of managing regulatory information, comprising:
accessing regulatory rules specifying content required to satisfy at least one regulatory approval objective for at least one regulatory agency in a respective target market in which a product is regulated; and
building a library of submittal components each specifying respective submittal content and each being linked to at least one approval objective.

40. The method of claim 39, further comprising generating submittal components based at least in part on compliance rules promulgated by at least one regulatory agency.

41. The method of claim 40, wherein at least one generated submittal component specifies submittal content satisfying regulatory compliance rules promulgated by multiple regulatory agencies.
